(19) United States
(12) Patent Application Publication
(10) Pub. No.: US 2007/0020075 A1
(43) Pub. Date: Jan. 25, 2007

(54) Vehicle passenger lift

(76) Inventor: James B. Kelly III, New York, NY (US)

Correspondence Address: GREENBERG TRAURIG, LLP, MET LIFE BUILDING, 200 PARK AVENUE, NEW YORK, NY, 10166, US

(21) Appl. No.: 11/169,816

(22) Filed: Jun. 29, 2005

(51) Int. Cl. B60P 1/00

(52) U.S. Cl. 414/540

(57) ABSTRACT

The invention provides a lift for a vehicle, such as automobiles, vans and the like, comprising: a platform, a track connected to the undercarriage of a vehicle, a support member connecting the platform to the track, and an actuator operatively connected to the platform. The platform is adapted to move between a plurality of positions including a mounting position at about ground level, a plurality of vehicle access positions, including between the front and rear side doors, or between the driver's side and passenger's side doors, or between all the access points a vehicle. The platform can also be moved to a stowed position substantially underneath the vehicle.

### BACKGROUND OF THE INVENTION

Running boards or similar fixed stepping assists to the side of a motor vehicle are known, especially to a vehicle with a relatively high ground clearance. However, these fixed running boards and other stepping assists have had several drawbacks. First, fixed running boards are not very effective in reducing the initial step height for the vehicle user as they are too high. Also, a fixed running board often extends a significant distance from the side of the vehicle. Finally, a fixed running board or step reduces the ground clearance of a vehicle, and can often be damaged or torn off entirely when the vehicle is used for offroad driving.

Existing retractable steps for use with a vehicle either do not stow underneath the vehicle, must be detached to stow away or store, or are only designed to move in one direction. These vehicle lifts do not move from one door to another.

### SUMMARY OF THE INVENTION

The invention provides a system and method for assisting a subject—a person or animal for example—into a vehicle via a lift with a platform adapted to move between a plurality of positions about the vehicle. The lift comprises: a moving platform, a track connected to the undercarriage of a vehicle, a support member connecting the platform to the track, and an actuator operatively connected to the platform to enable it to move to various positions. The platform is adapted to move between a plurality of positions including a mounting position at about ground level, a plurality of vehicle access positions, and a stowed position substantially underneath the vehicle. The vehicle access positions comprise an access to a front part (e.g., a front door) of the vehicle and an access to a rear part (e.g., any number of rear doors) of the vehicle. The access positions also can include an access to a passenger side of the vehicle and an access to a driver side of the vehicle. The vehicle can comprise two front wheel wells and a plurality of rear wheel wells and the lift's stowed position can be between the front and rear wheel wells of the vehicle. The lift can include a controller operatively connected to the actuator, wherein the controller is adapted to control movement of the platform between the positions. The actuator can be adapted to be operatively connected to a vehicle battery such that the vehicle battery powers the lift.

The vehicle lift can also include a platform lock adapted to lock the platform into any of it's positions. The platform can be operatively connected to a sensor adapted to sense a load on the platform, and the platform can move from the mounting position to a load removal position.

The lift can be adapted to move a load weighing at least about that of a fully grown human being. The platform design can comprise a weight capacity of at least about 300 pounds, whereby the lift can be designed to move a load of at least about 300 pounds. The platform design can include a width of about 24 inches; a depth of about 18 inches; and a thickness of about a ¼ inch.

The invention also provides a method for assisting a subject into a vehicle using a lift that comprises a moving platform, a track connected to the undercarriage of a vehicle, a support member connecting the platform to the track, and an actuator operatively connected to the platform to enable it to move to various positions. The platform is adapted to move between a plurality of positions including a mounting position at about ground level, a plurality of vehicle access positions, and a stowed position substantially underneath the vehicle. The method comprises moving the lift form the stowed position to the mounting position; placing the subject on the lift at the mounting position; raising the lift to the vehicle access position selected from a plurality of vehicle access positions; and allowing the subject to move from the lift into the vehicle.

The vehicle access positions comprise: an access to a front part of the vehicle; and an access to a rear part of the vehicle. The access positions can comprise an access to a passenger side the vehicle and an access to a driver side of the vehicle.

The method can also comprise any of the following features singly or in any combination:
adapting the lift to allow controlled movement between the positions;
adapting the platform to lock into any of the positions, for instance at a position where a human is put on or steps off the lift, and subsequently moving the lift.
adapting the lift to be retained in a fixed position until a load is removed from the platform at the load removal position;
adapting the platform to move by using power from the vehicle's battery;
adapting the platform to move to the stowed position between two front wheel wells and a plurality of rear wheel wells included on a vehicle; or
adapting the platform to move from the load acceptance position to the load removal position any number of times.

A non limiting illustration of the invention's use is described using a person as an example of a subject being assisted into a vehicle. The vehicle platform moves from a stowed position substantially underneath the vehicle and between a front and rear wheel of a vehicle to a load acceptance position, for example, a mounting position at about ground level. The person, standing on the ground, steps onto the platform at the ground level position. It may be locked against accidental movement. The platform then moves the person up to a vehicle access position, for example a front door or a rear door on either the passenger's side or driver's side of the vehicle, optionally locking against accidental movement. The person can then step easily into the vehicle at the access point, having been lifted from the ground by the platform. At the load removal position, the lift can be adapted not to move until the load is removed—in this case until the person steps into the vehicle. Once the load is removed, the platform can then move back into the stowed position, or it can move to a load acceptance position, so as to aid another person into the vehicle, for example. Once the platform is in the stowed position, the vehicle is ready for travel.

The load acceptance position can also be any of the access positions of the vehicle, and the load removal position can be the ground level position, as for example when a person uses the platform to aid in exiting a vehicle.

### DETAILED DESCRIPTION OF THE DRAWINGS

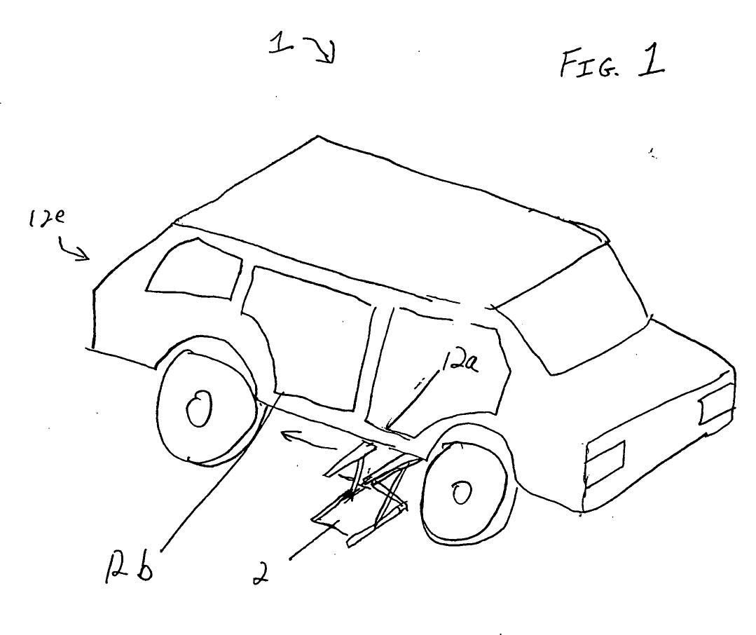

FIG. 1 shows a vehicle with an embodiment of the vehicle lift.

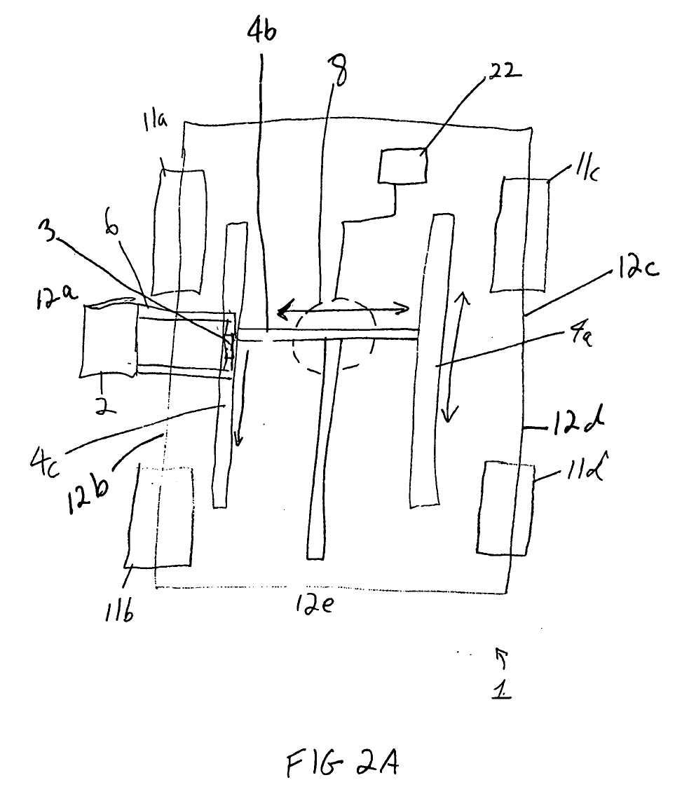

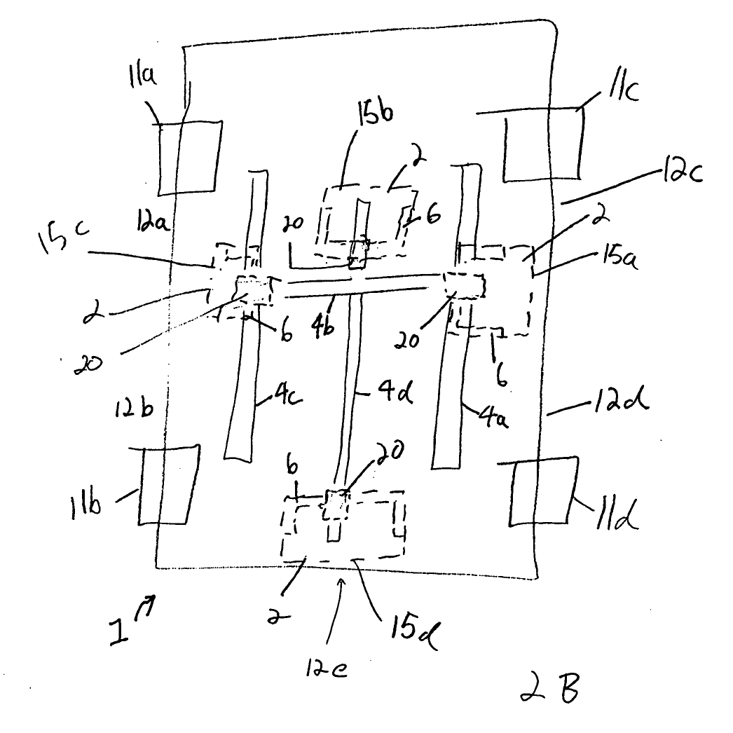

FIGS. 2A and 2B show the underside of a vehicle with an embodiment of the vehicle lift; FIG. 2C shows side and rear views of a vehicle with an embodiment of the vehicle lift.

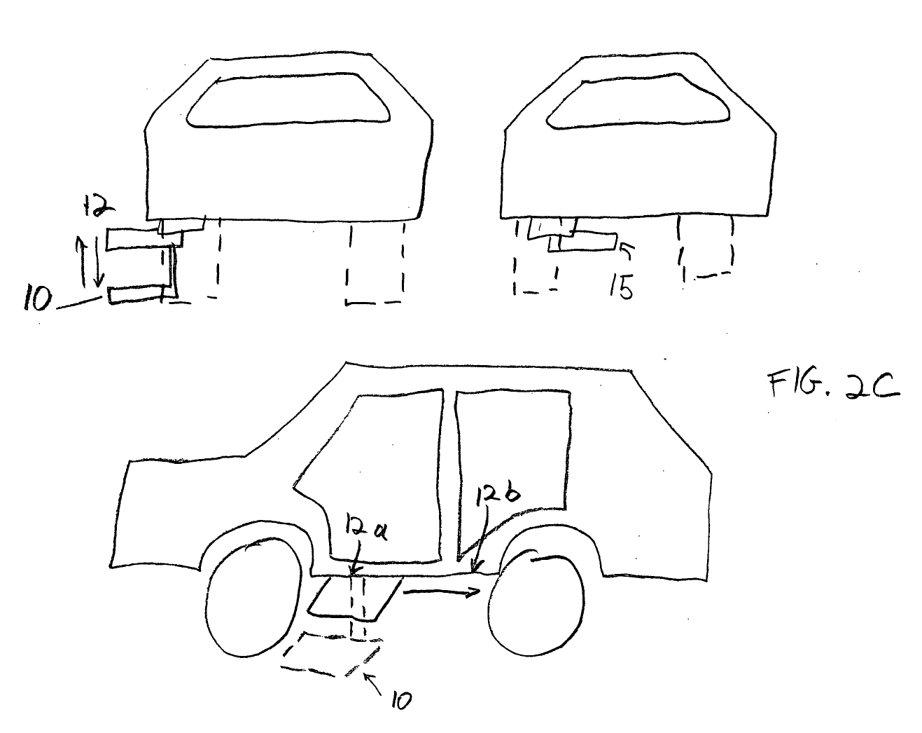

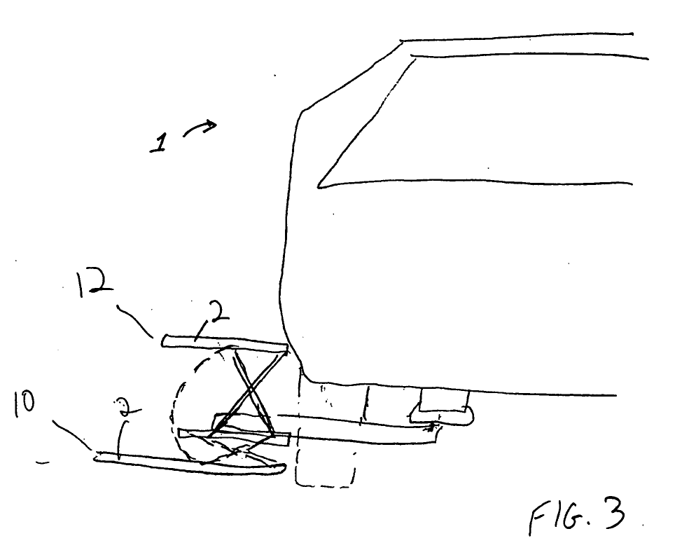

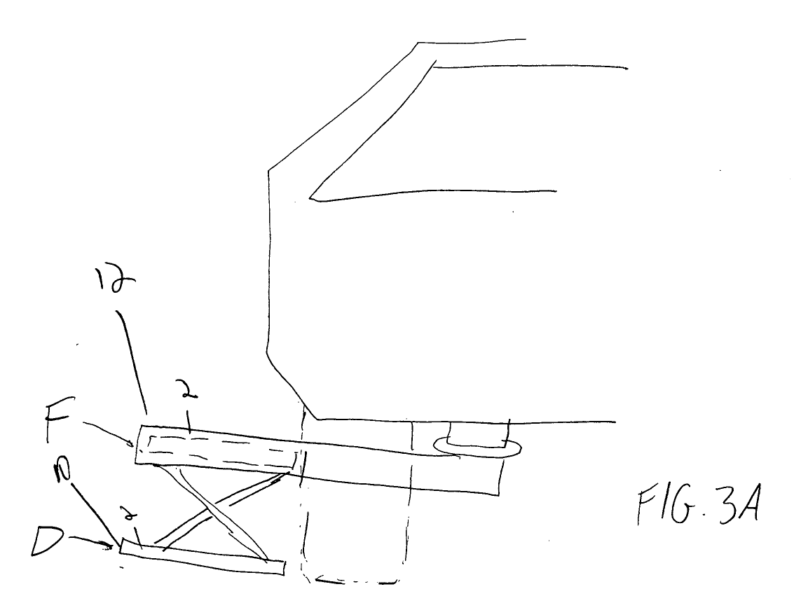

FIGS. 3 and 3A shows a lift platform adapted to move to a mounting position and a vehicle access position.

FIG. 4 shows a controller for controlling platform movement between the positions.

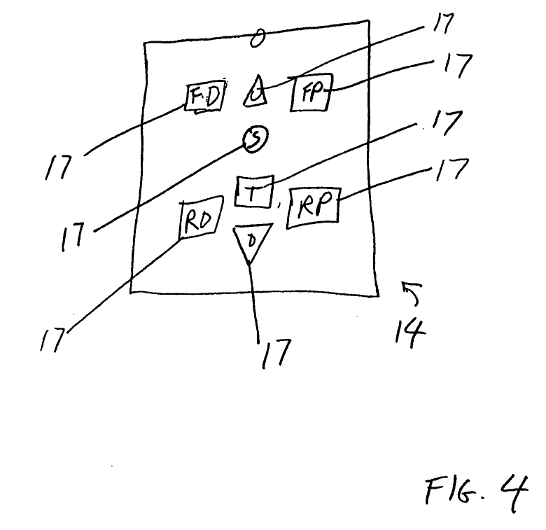

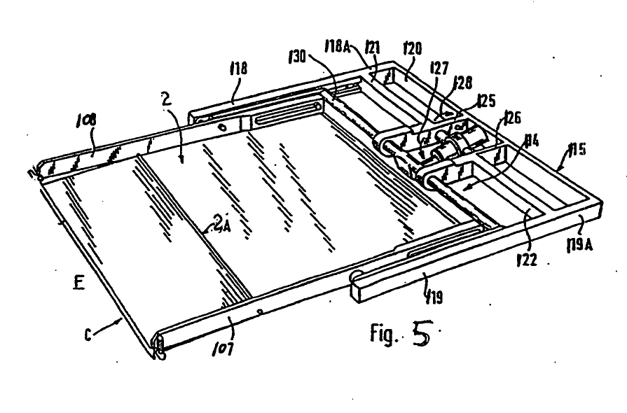

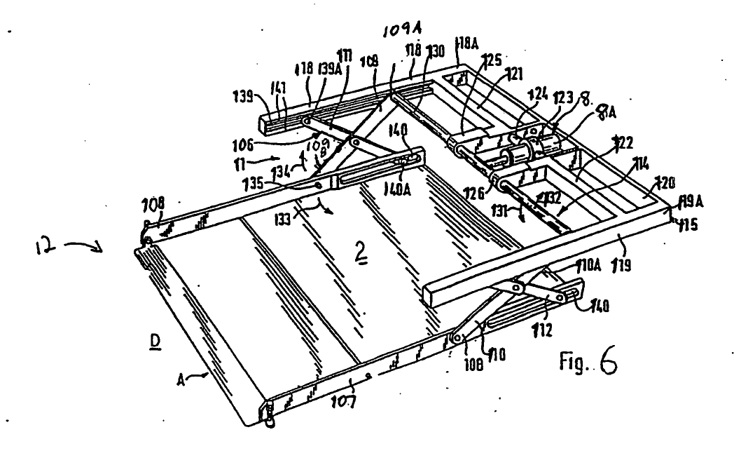

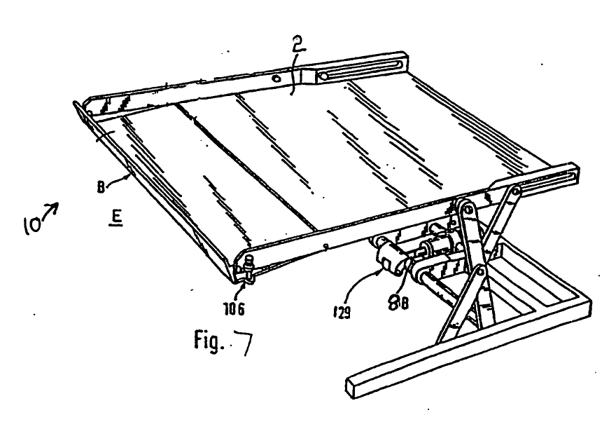

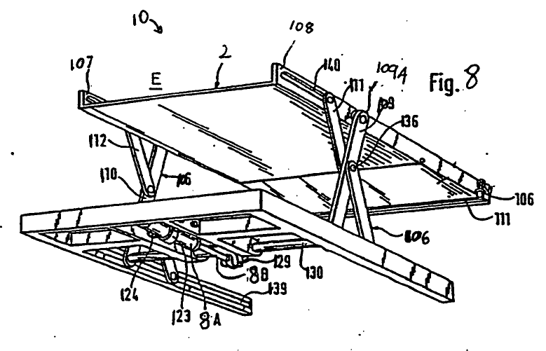

FIGS. 5 to 8 show a vehicle lift vehicle lift arrangement comprising a lift platform adapted to move between a mounting position and a vehicle access position.

### DETAILED DESCRIPTION OF THE INVENTION

The invention provides a system and method for assisting a subject into a vehicle via a lift platform adapted to move between a plurality of positions. The following example describes the present invention as used on an automobile, trucks, vans, and similar vehicles. The invention comprises a lift for a vehicle, comprising: a platform, a track connected to the undercarriage of a vehicle, a support member connecting the platform to the track, and an actuator operatively connected to the platform. Throughout the Figures, the same numbers refer to the same elements. FIGS. 1 AND 2 show a vehicle 1 with an embodiment of the vehicle lift. While the lift is shown attached to a Sports Utility Vehicle (SUV), the lift can be adapted to any passenger vehicle 1, for example, a car, truck, van, bus, jeep, or the like. The exemplary use for the vehicle lift is to aid a subject—a handicapped person or animal for example—into a vehicle 1. As such, while the lift will be discussed in terms aiding or assisting a person into a vehicle, this is but one non-limiting example of a use for a lift.

The lift includes a platform 2. This platform 2 is adapted to move between a number of positions, including vehicle access positions.

FIGS. 2A and 2B show the underside of a vehicle 1 with the vehicle lift operatively attached. The vehicle lift comprises a track 4a, 4b 4c, and 4d. The track is shown in the exemplary embodiment as a number of tracks: two side tracks 4a and 4c along each side of a vehicle 1 and a cross track 4b laterally situated against the side tracks 4a, 4c. A support member 6 connects the platform 2 to the track 4c. This platform 2 is adapted to move between a plurality of vehicle access positions 12a, 12b, 12c, 12d and 12e. This platform is also adapted to move to a stowed position, 15a, 15b, 15c and 15d, substantially underneath the car, shown in FIG. 2B.

An actuator is operatively connected to the platform. The actuator 8 can include any device adapted to power to the mechanical system that allows the platform 2 to move from position to position.

As shown in FIG. 3, the platform 2 is adapted to move to a mounting position 10 around ground level. As the platform 2 is designed to accept a person into it, a person can mount or dismount the platform at ground level. As such, the mounting position 10 is a position for mounting or dismounting the platform 2. The platform is also adapted to move from the mounting position 10 to a vehicle access position 12.

Because the platform 2 is designed to aid a full grown human being in entering a vehicle 1, the lift design can include a weight capacity of at least approximately 300 lbs, which it can move. As such, the lift is adapted to accept, lift and lower at least approximately 300 lbs on the platform 2. The platform can be made of any suitable material, such as plastic or metal, to accommodate and lift a person—a ¼ inch sheet of stainless steel for example.

Returning to FIGS. 2A and 2B, the lift is designed to provide access to different access points of a vehicle 1 by moving the platform to a number of different positions. For example, the support member 6 can be designed to move along a side track 4c from a front portion 12a of the vehicle 1 to a rear portion 12b of the vehicle or vice-versa. Accordingly, the platform 2 can also move between the front and rear positions 12a and 12b of the vehicle 1 such that a person can access the vehicle 1 via either a front door or any rear door of the vehicle 1, including any doors situated between a front door and a rearmost door.

As shown in FIG. 2A, the rear portion 12b, 12d and 12e of the vehicle includes an access via the trunk.

The lift can be designed to allow the platform 2 to move between the two sides of the vehicle, namely the driver's side 12c and 12d, or the passenger side 12a and 12b. Vehicles can be designed with the driver's side 12c and 12d on either side of the vehicle 1; for the purposes of describing the invention, it does not matter which side of the vehicle 1 is the driver's side 12c and 12d or the passenger's side 12a and 12b. Driver's side 12c and 12d and passenger's side 12a and 12b designate opposing sides of the vehicle 1.

As FIGS. 2A and 2B show, track 4b laterally disposed with respect to side tracks 4a and 4c allows the support member 6 to move between the driver's side track 4a and the passenger's side track 4c. This allows the platform 2 to move underneath the vehicle 1 to a driver's side 12c and 12d access or a passenger's side 12a and 12b access. As such, the lift could help a person enter the front or rear door on the driver's side 12c and 12d, and then move the platform 2 to help a person access the vehicle via the front or rear door on the passenger's side 12a and 12b.

The lift can be adapted to lock the platform 2 into any position, including the vehicle access positions 12a, 12b, 12c, 12d and 12e; the mounting position 10 or the stowed position 15. A platform 2 lock for locking the platform includes devices and mechanisms for keeping the device locked in place, as well as configurations that use support forces to hold the platform 2 into place when in a given position.

The lift can include a sensor (not shown) adapted to sense a load upon the platform. The sensor could be operatively connected to the actuator 8 such that the platform does not move until a load is removed from the platform. In particular, the sensor senses a load when the load is initially placed on the platform 2, for example when a person steps upon the platform 2 that is at the mounting position or, if the person is using the lift to disembark from the vehicle 1, the person steps upon platform 2 at a vehicle access position 12. Once the load is moved to the target position, such as from the mounting position 10 to the vehicle access position 12, the sensor could be adapted to stay in the target position until the load is completely removed. For example, the sensor could act as an inhibitor (not shown), sending an inhibitor signal to the actuator 8 or the power source 22 until the load is removed, or sending a permission or activation signal to the actuator 8 or the power source 22 to permit platform 2 movement upon removal of the load.

As shown in FIG. 2B, a stowed position 15 is substantially underneath the vehicle. The lift can be adapted such that the platform 2 can be moved into the stowed position 15 without the need to detach the platform 2. The lift configuration is designed to allow the vehicle to operate normally when the platform 2 is in the stowed position 15. The lift can be stowed in a stowed position 15a and 15c between the wheel wells 11a, 11b, 11c and 11d of the vehicle 1. It can also be stowed in any stowed position 15 that allows the vehicle to properly operate, such as toward the center 15b or the rear 15d. FIG. 2C, wherein the same numbers represent the same elements, shows an example of the vehicle lift from a side and back perspective.

In one exemplary arrangement, shown in FIGS. 5 to 8, a vehicle lift comprising a lift platform 2 capable of moving between a vehicle access position 12 and a mounting position 10 includes a non-limiting example of a lift and lower mechanism 106. This arrangement is but one embodiment of any number of platform lifting mechanisms that can be used with or adapted to the present invention: other non-limiting examples of such methods and apparatus can be found in the following U.S. Patents, each of which are incorporated in their entirety: U.S. Pat. Nos. 6,435,804; 6,641,158; 4,083,429; 4,711,613; 4,958,979; 5,523,973. The platform 2 is connected via the lift and lower mechanism 106, which can include a supporting link 109, 110 and a guide link 111, 112 situated on the two lateral edges 107, 108 of the platform, to a suitable actuator 8, which enables the platform 2 to be actuated in order to raise or lower it. It is possible in this way, by actuating the actuator 8, to cause the platform 2 to move between a lower end position D and an upper end position E, as illustrated in FIGS. 5 to FIG. 8, for example, At least one of the end positions D, E is at a different level A and B to the level C at which the connection 114 between the lift and lower mechanism 106 and the actuator 8 is situated.

The platform 2 is arranged so that it can move between a level A and a level B respectively situated below and above the drive connection 114 and the level C for same, as illustrated in the figures.

The attitude of the platform 2 is horizontal during the period for which it moves between the positions D and E due to lift and lower mechanism 106. The platform 2, which is illustrated is in the form of a flat sheet, but can exhibit some other desired form. Platform dimensions can be sufficient to allow a fully grown human being to fully step up on the lift, exemplary dimensions being a width of about 24 inches, a depth of about 18 inches; and a thickness of about a ¼ inch. The platform 2 is supported by a support member, here shown as frame 115, which in turn may be supported by a guide arrangement or track situated, for example, on the underside of a vehicle. The guide arrangement may consist of a guide channel, for example, attached to the chassis frame (not shown) of the vehicle, along which channel the lifting frame 115 is supported via a mount (not shown) in such a way as to be capable of being freely guided, conveniently in a telescopic fashion, between a storage position 15 in which it is withdrawn substantially underneath the vehicle 1, as illustrated in FIG. 2B, for example, and an extended lifting position in which it is extended, for example, laterally away from the vehicle and to the outside of the vehicle, as illustrated in FIG. 1, FIG. 2A and FIG. 3, for example.

The frame 115 can exhibit a peripheral form of ‘C’-section and can be constructed from channel shaped lateral members 118, 119 with transverse members 120, 121, 122 attached to it at one of its free ends 118A, 119A.

A hydraulic cylinder arrangement 8 or some other appropriate jack 8 powered by fluid or actuated mechanically can be supported, for example, in such a way that it is free to pivot in the vicinity of the transverse members 120, 121, 122. For example, a piston cylinder 8A can be supported by a bearing 123 which encloses the piston cylinder 8A, and which, via projecting bearing shafts 124, which are supported by bracing struts 125, 126 attached to the transverse members 120, 121, 122, are supported in such a way that they are free to pivot in the direction of the arrows 127, 128. A piston rod 8B which is capable of being caused to extend from the piston cylinder 8A, is attached via an articulated joint 129 to a shaft 130 forming part of the actuator 8, which shaft is supported by the bracing struts 125, 126 in such a way that it is free to pivot in the direction of the arrows 131, 132. The pivot shaft 130 is rigidly connected to the free ends 109A and 110A of the lift and lower mechanism 106 situated to either side of the frame 115 and the platform 2.

Actuation of the jack 8 will cause the shaft 130 to rotate in either direction 131, 132, and will cause the supporting links 109, 110 to pivot about the shaft 130 in the direction of the arrows 133, 134.

The other end 109B, 110B of the supporting links 109, 110 is pivotally attached to the two lateral edges 107, 108 of the platform via a swiveling connection 135, and the ends 109A, 110A and 109B, 110B are so arranged as to be maintained at the same level as the platform 2 and as the frame 115.

The guide links 111, 112, which are attached to their corresponding supporting links 109, 110 via an appropriate link 136 at the point of intersection between the links 109, 111 and 110, 112, so that they can pivot in relation to one another, appropriately extend in a zigzag fashion along the corresponding supporting link 109, 110 in a plane situated to either side of the supporting link 109, 110. The possibility is afforded in this way for the simple and effective connection of the end surfaces 107, 108, etc., of the platform to the frame 115.

The guide links 111, 112 are freely guided by guides 139, 140 extending along the frame 115 and end surfaces 107, 108 via guide arrangements 139A, 140A interacting with same for the purpose of maintaining the platform 2 in the desired attitude during raising of same and while it is being held stationary in the supporting position F and in the loading position D, E. The guides 139, 140 can take the form of internal cavities in the lateral members 118, 119 of the frame with corresponding end walls 141, and of an elongated slot in the end walls 107, 108.

In another non-limiting embodiment, the supporting position F can be substantially at the vehicle access position. In such an embodiment, the end positions would comprise position D and F. This configuration is shown at FIG. 3A; another non-limiting example of this configuration may also be found at FIG. 2C.

The function of the lift arrangement described above should have emerged from what is stated above, although the following brief comments may be made: the possibility is afforded in the extended position beyond the side of the vehicle, for example after displacement on rollers (not shown) which are supported by the frame 115, of raising the platform 2 into the desired position by actuating the driving jack 8 so that the shaft 130 is caused to rotate in the desired direction 131 and 132, depending on whether the jack 8 is caused to be shortened or lengthened. In conjunction with this the shaft 130 causes the supporting links 109, 110 to rotate in either direction 133 and 134 in order either to lower or to raise the lifting platform 2 towards the end positions D and E from its lifting position.

Returning to FIGS. 2A and 2B, the support member 6 that connects the platform 2 to the track 4 can be mounted on the guide track 4a to 4d, by a mount 3. The track 4 can be designed with an actuated drive mechanism, such as a chain, cable, or wheel-type drive, to move the support member 6 along the length of side of the vehicle between the wheel wells 11a, 11b or 11c, 11d via track 4a or 4c. The platform 2 can also be moved along the length of the vehicle to the back of the vehicle 1 by a track so situated 4d. The support member 6 can also be adapted to move transversely along the width of the vehicle 1 on a track 4b designed to move from the driver's side 12c, 12d to the passenger's side 12a, 12b via a suitable actuated drive mechanism. In such case, the support member could be adapted to rotate or swivel a sufficient amount (e.g. 180 to 360 degrees) at a clearance space underneath the vehicle such that the platform 2 is able to extend from either the driver or the passenger side of the vehicle 1. This can be done by rotatably mounting the support member on the mount (e.g. a rotating mount), which is connected to a drive mechanism or actuator 8. Any actuator 8 used to drive any of the components of the lift can be operatively connected to the vehicle battery as the power source 22.

Maneuvering the platform 2 can be effected in a number of ways, for example by means of controls which are contained within the vehicle, although a remote control for the lift can be designed.

FIG. 4 shows a controller 14 for controlling platform 2 movement between the positions. Identification of the positions and the actuator 8 is made by reference to FIGS. 1 to 3. The controller 14 is operatively connected to the actuator 8, and is adapted to control the movement of the platform 2 into any of the positions 12 and 15. For example, the controller 14 could be designed with any number of actuators 17 (i.e. buttons) that transmit a signal to a receiver that instructs the lift to move the platform to a targeted position 12 and 15. For example, one activator 17FD could control movement of the platform to the corresponding vehicle access position 12c at the driver's side front door. The activators 17 corresponding to the vehicle access position 12 include an activator 17FP for the front passenger's side door, activator 17RD for the rear door on the driver's side, activator 17RP for the rear door on the passenger's side, and activator T for the trunk, wagon area, or other rear entry.

An activator 17 can be adapted to control other types of platform movement. The controller 14 can, for example, move the platform 2 from the mounting position 10 to the vehicle access position 12 by using up 17U or down 17D buttons, and vice-versa; this movement could be repeated when loading several subjects into one vehicle access point. The controller 14 can also include an activator 17S for moving the platform 2 into a stowed position.

It should be understood that the above description is only representative of illustrative and non-limiting embodiments and examples. For the convenience of the reader, the above description has focused on a limited number of representative examples of all possible embodiments, examples that teach the principles of the invention. The description has not attempted to exhaustively enumerate all possible variations or even combinations of those variations described. That alternate embodiments may not have been presented for a specific portion of the invention, or that further undescribed alternate embodiments may be available for a portion, is not to be considered a disclaimer of those alternate embodiments. One of ordinary skill will appreciate that many of those undescribed embodiments, involve differences in technology and materials rather than differences in the application of the principles of the invention. Accordingly, the invention is not intended to be limited to less than the scope set forth in the following claims and equivalents.

1. A lift for a vehicle, comprising:
a movable platform;
a track connected to the undercarriage of a vehicle;
a support member connecting the platform to the track; and
an actuator operatively connected to the platform;
wherein the movable platform is adapted to move between a plurality of positions including:
a) a mounting position at about ground level;
b) a plurality of vehicle access positions; and
c) a stowed position substantially underneath the vehicle.

2. The lift of claim 1, wherein the vehicle access positions comprise:
an access to a front part of the vehicle

3. The lift of claim 1, wherein the vehicle access positions comprise:
an access to a rear part of the vehicle.

4. The lift of claim 1, wherein the access positions comprise:
an access to a passenger side the vehicle.

5. The lift of claim 1, wherein the access positions comprise:
an access to a driver side of the vehicle.

6. The lift of claim 1 which further comprises:
a controller operatively connected to the actuator, wherein the controller is adapted to control movement of the platform between the positions.

7. The lift of claim 1 which further comprises:
a platform lock adapted to lock the platform into any of the positions.

8. The lift of claim 1 which further comprises:
a sensor adapted to sense a load on the platform, the sensor being operatively connected to the platform, whereby the platform can move from the mounting position to a load removal position.

9. The lift of claim 1 which can move a load weighing at least about that of a fully grown human being.

10. The lift of claim 9 wherein the platform is designed such that it comprises:
a weight capacity of at least about 300 pounds, and the lift is designed to move a load of at least about 300 pounds.

11. The lift of claim 10 wherein the platform design comprises:
a width of about 24 inches;
a depth of about 18 inches; and
a thickness of about a ¼ inch.

12. The lift of claim 1 wherein the actuator is adapted to be operatively connected to a vehicle battery such that the vehicle battery powers the lift.

13. The lift of claim 1 wherein the vehicle comprises two front wheel wells and a plurality of rear wheel wells and the lift's stowed position is between the front and rear wheel wells of the vehicle.

14. A method for assisting a subject into a vehicle using a lift comprising:
a movable platform;
a track connected to the undercarriage of a vehicle;
a support member connecting the platform to the track; and
an actuator operatively connected to the platform;
wherein the movable platform is adapted to move between a plurality of positions including:
a) a mounting position at about ground level;
b) a plurality of vehicle access positions; and
c) a stowed position substantially underneath the vehicle; which comprises:
moving the lift form the stowed position to the mounting position;
placing the subject on the lift at the mounting position;
raising the lift to the vehicle access position selected from a plurality of vehicle access positions; and
allowing the subject to move from the lift into the vehicle.

15. The method of claim 14, wherein the vehicle access positions comprise:
an access to a front part of the vehicle; or
an access to a rear part of the vehicle.

16. The method of claim 14, wherein the access positions comprise:
an access to a passenger side the vehicle; or
an access to a driver side of the vehicle.

17. The method of claim 14 which comprises:
controlling movement of the lift between the positions.

18. The method of claim 14 which further comprises:
locking the lift into any of the positions.

19. The lift of claim 14 which further comprises:
retaining lift in a suitably fixed position until a load is removed from the platform at a load removal position.

20. The method of claim 14 wherein the subject is a human.

21. The method of claim 14 which comprises:
moving the platform by using power from the vehicle's battery.

22. The method of claim 14 which further comprises:
adapting the platform to move between two front wheel wells and a plurality of rear wheel wells of the vehicle, the vehicle comprising the two front wheel wells and the plurality of rear wheel wells.

23. The method of claim 14 which comprises:
adapting the platform to move from a load acceptance position to a load removal position any number of times.
